(19) United States
(12) Patent Application Publication
(10) Pub. No.: US 2002/0016716 A1
(43) Pub. Date: Feb. 7, 2002

(54) Internet shopping mall server and shopping information providing method thereof

(76) Inventors: Soon-kyo Hong, Seoul (KR); Seiichiro Suzuki, Seoul (KR); Eun-jung Cho, Seoul (KR); Do-weon Kim, Seoul (KR); Hyun-sun Min, Anyang-si (KR); Jung-ran Jung, Suwon-si (KR)

Correspondence Address: STAAS & HALSEY LLP, 700 11TH STREET, NW, SUITE 500, WASHINGTON, DC, 20001, US

(21) Appl. No.: 09/850,407

(22) Filed: May 8, 2001

(30) Foreign Application Priority Data
May 8, 2000 (KR) 2000-24436

(51) Int. Cl. G06F 17/60

(52) U.S. Cl. 705/1

(57) ABSTRACT

A shopping information providing method implemented by an Internet shopping mall server, the shopping information providing method includes receiving a request of product explanation on a predetermined product from a customer; transmitting an operating principle selection page to select one of the operating principles of the predetermined product to an Internet access portal of the customer; receiving selection information on the selected one of the operating principle from the Internet access portal; and transmitting a multimedia document to simulate the selected one of the operating principles to the Internet access portal. Therefore, customers can easily understand the operating principles of a product. In addition, the Internet shopping mall operator can enhance customer loyalty to the Internet shopping mall and the goodwill of the Internet shopping mall.

### CROSS-REFERENCE TO RELATED APPLICATIONS

This application claims the benefit of Korean Application No. 2000-24436, filed May 8, 2000, in the Korean Industrial Property Office, the disclosure of which is incorporated herein by reference.

### BACKGROUND OF THE INVENTION

1. Field of the Invention

The present invention relates to an Internet shopping mall server and a method of providing, using the Internet shopping mall server, shopping information, and more particularly, to an Internet shopping mall server and a shopping information providing method thereof in which shopping information on products sold at the Internet shopping mall is provided to a customer through an Internet access portal.

2. Description of the Related Art

The number of shopping malls based on the Internet are rapidly increasing and competition among each shopping malls is becoming fiercer. Accordingly, to boost product sales, most Internet shopping malls are providing various information on products they sell. Specifically, for manufactured goods, general household goods, such as garments and cosmetics, the customers are not limited to any particular sex or age group, and thus require little or no usage instruction. For more specialized goods, such as a computer system or an audio system, the customers typically belong to a demographic of specific age groups that are usually well informed about the product before making a purchase.

However, for home electrical appliances, which are more complicated and require more instruction than general household goods, customers are not always well informed of the usage and operating principles at the time of purchase. In addition, as the product life cycles of home electrical appliances become shorter, and various models are introduced with new functions, providing information on home electrical appliances is becoming more important. Since home electrical appliances are mainly used in the home and are operated by electrical power, a fire hazard due to a leakage of electricity always exists (i.e., shock hazards, short circuits etc.), and thus, informing customers about the potential dangers of such appliances is also important.

However, Internet shopping malls or the sites of manufacturers of home electrical appliances, where home electrical appliances are sold, currently provide product information only on product specifications and/or shapes (or sizes).

### SUMMARY OF THE INVENTION

To solve the above and other problems, it is an object of the present invention to provide an Internet shopping mall server and a shopping information providing method for providing shopping information by way of multimedia documents to explain the operating principles of products.

It is another object of the present invention to provide an Internet shopping mall server and a shopping information providing method for providing useful shopping information so as to generate strong customer satisfaction.

Additional objects and advantages of the invention will be set forth in part in the description which follows and, in part, will be obvious from the description, or may be learned by practice of the invention.

To accomplish the above and other objects of the present invention, a shopping information providing method using an Internet shopping mall server includes receiving a request for product explanation on a predetermined product from a customer; transmitting an operating principle selection page to select any one of operating principles of the predetermined product to an Internet access portal of the customer; receiving selection information on the operating principle selected by the customer from the Internet access portal; and transmitting a multimedia document to simulate the selected operating principle to the Internet access portal.

According to an aspect of the present invention, the predetermined product comprises a home electrical appliance.

According to another aspect of the present invention, the home electrical appliance is any one of a washing machine, a vacuum cleaner, a microwave oven, a gas oven, and an air conditioner.

According to yet another aspect of the present invention, the predetermined product comprises a washing machine, and the multimedia document comprises a hypermedia document to link to a sound to simulate the noise or vibration of a washing machine.

According to still another aspect of the present invention, the predetermined product comprises a washing machine, and the multimedia document comprises a hypermedia document to link to sound and moving pictures to simulate the noise or vibration of a washing machine.

According to still yet another aspect of the present invention, the predetermined product comprises a washing machine, and the multimedia document comprises a hypermedia document to link to moving pictures to show the principle of washing off dirt.

According to a further aspect of the present invention, the predetermined product comprises a washing machine, and the multimedia document comprises a hypermedia document to link to sound and moving pictures to simulate a washing process according to a strength of the water current in the washing machine.

According to a yet further aspect of the present invention, the multimedia document comprises a hypermedia document to link to sound and moving pictures to display the appropriate rotations of a motor depending on the material of the clothing items and simulating a washing process according to the water current caused by the motor rotations.

According to another embodiment of the present invention, an Internet shopping mall server comprises a product database to store information on products; a communication interface to communicate data through an Internet; a selection information receiving module to receive a request for a product explanation on a predetermined product from an Internet access portal of a customer, to transmit an operating principle selection page used to select any one of the operating principles of the predetermined product to the Internet access portal through the communication interface, and to receive operating principle selection information from the Internet access portal through the communication interface; and a multimedia document providing module to extract a multimedia document to simulate operating principles according to the operating principle selection information, from the multimedia document database, and to transmit the multimedia document to the Internet access portal.

According to an aspect of the present invention, the product comprises a home electrical appliance.

According to another aspect of the present invention, the home electrical appliance comprises any one of a washing machine, a vacuum cleaner, a microwave oven, a gas oven, and an air conditioner.

According to yet another aspect of the present invention, the multimedia document comprises a hypermedia document to link to a sound to simulate the noise or vibration of a washing machine.

According to still another aspect of the present invention, the multimedia document comprises a hypermedia document to link to a sound and moving pictures to simulate the noise or vibration of a washing machine.

According to a further aspect of the present invention, the multimedia document comprises a hypermedia document to link to moving pictures to show the principle of washing off dirt.

According to a yet further aspect of the present invention, the multimedia document comprises a hypermedia document to link to a sound and moving pictures to simulate a washing process according to the strength of the water current in the washing machine.

According to a still further aspect of the present invention, the hypermedia document links to a sound and moving pictures to display the appropriate rotations of a motor depending on the material of the clothing items, and to simulate a washing process according to the water current caused by the motor rotations.

### BRIEF DESCRIPTION OF THE DRAWINGS

The above and other objects and advantages of the present invention will become more apparent and more readily appreciated by describing in detail preferred embodiments, taken in conjunction with the accompanying drawings in which:

FIG. 1 is a schematic diagram of an Internet-based shopping system including an Internet shopping mall server according to an embodiment of the present invention;

FIG. 2 is a block diagram of the Internet shopping mall server of FIG. 1;

FIG. 3 is a block diagram of the structure of a retrieval path, which is hierarchically expressed, to explain the shopping information providing method by the Internet shopping mall server according to an embodiment of the present invention;

FIG. 4 is a block diagram of the structure of another retrieval path obtained by modifying the retrieval path of FIG. 3;

FIGS. 5A and 5B are block diagrams of the structure of a hypermedia document to explain washing principles;

FIG. 5C is an example of a web page to implement the structure of FIG. 5B;

FIG. 6A is a schematic diagram of the structure of a hypermedia document to explain noise or vibration;

FIGS. 6B and 6C are examples of web pages to implement the structure of FIG. 6A;

FIG. 7A is a block diagram of the structure of a hypermedia document to explain the washing process;

FIG. 7B is an example of a web page to implement the structure of FIG. 7A; and

FIG. 8 is a flowchart to explain the shopping information providing method according to an embodiment of the present invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

FIG. 1 is a schematic diagram of an Internet-based shopping system that uses an Internet shopping mall server 1 according to an embodiment of the present invention. Referring to FIG. 1, the Internet shopping system comprises Internet access portals 3a and 3b of customers and an Internet shopping mall server 1 to sell products to customers through an Internet 5. The Internet access portals 3a and 3b include personal computers, mobile phones, etc., with which customers access the Internet shopping mall server 1 through the Internet 5. An application program to display multimedia documents that explain the operating principles of a product through the Internet 5 is installed in the Internet access portals 3a and 3b. While not shown, it is understood that the Internet access portal 3c and 3b could also comprise personal digital assistants, terminals, or any other mechanism by which customers can access the Internet shopping mall server 1.

Here, the Internet shopping mall server 1 denotes both software and hardware, where the hardware comprises a special purpose or general purpose computer that implements the software. Typically, such software and hardware is managed by the manager of the shopping mall (i.e., the owner of the Internet shopping mall server 1). Meanwhile, the Internet 5 may be replaced by other networks such as a public switched telephone network (PSTN), a packet switched data network (PSDN), a cable TV network, a wireless communication network, a local area network, a wide are network, a metropolitan area network or any other mechanism through which a portal 3a or 3b can access the server 1. When the Internet is replaced by another network, the network interfaces or communication protocols of the Internet access portals 3a and 3b and the Internet shopping mall server 1 should be changed.

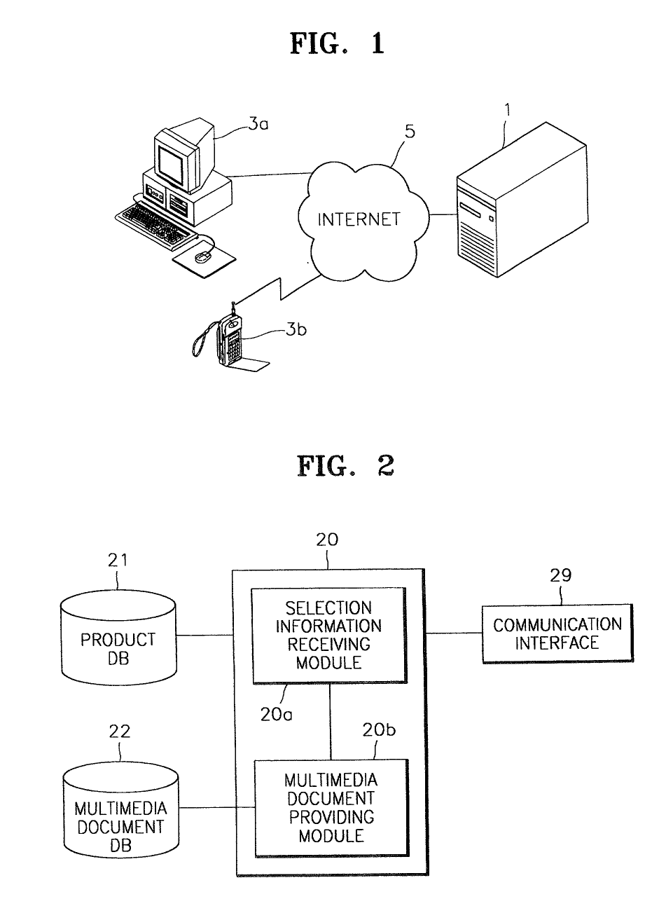

FIG. 2 is a block diagram of the Internet shopping mall server 1 of FIG. 1. Referring to FIG. 2, the Internet shopping mall server 1 comprises a product database 21 to store information on various products sold at the shopping mall, including home electrical appliances, a multimedia document database 22 to store multimedia documents on the products, a control module 20 to sell the products on which information is stored in the product database 21 and to transmit the multimedia documents stored in the multimedia document database 22, and a communication interface 29 to communicate data with the outside.

Product information stored in the product database 21 includes the names, models, sizes, prices, specifications, image information, etc., of the products, and in particular, home electrical appliances, sold at the Internet shopping mall.

The home electrical appliances of the present invention include those products that are intended for home use, and generally need to be activated in some fashion in order to perform the needed functions. More specifically, the products include washing machines, refrigerators, gas ovens, microwave ovens, and air conditioners. However, it is understood that the products could also include larger items for which an explanation of operating principles would be useful, such as automobiles, aircraft, boats. Further, it is understood that the products could also be an industrial customer such that the product could be heavy machinery, robotics, or any other similar items used outside of a typical home environment.

In the multimedia document database 22, hypermedia documents linked to moving pictures and/or sound are stored as multimedia documents to explain the operating principles such as basic scientific concepts, related effects, and operating procedures. Here, multimedia documents include temporal and/or spatial combination of pieces of audiovisual media. Usually, a person who watches the document (hereinafter, referred to as a “customer”) can change the display order and contents of the document by inputting commands. Though multimedia documents are described here as “documents”, the documents simulate the experience of watching television because the customer can watch moving pictures while hearing sound. By expressing the operating principles of products and home electrical appliances in multimedia documents, the operating principles, including basic scientific concepts, related effects, and operating procedures, can be shown by moving pictures, including animations and moving images, and/or sound so that customers can easily understand the principles. A hypermedia document is a multimedia document that has a hypermedia structure. In the hypermedia structure, moving pictures or sounds are linked to the hypermedia document through a text anchor or an image anchor. Examples of such multimedia documents include animated GIFs, DHTML, Active X control, Javascript, Java Applets, Quicktime, MPEG, and Shockwave.

The control module 20 has a selection information receiving module 20a and a multimedia document providing module 20b. The selection information receiving module 20a transmits an operating principle selection page, which a customer uses to select any one of the operating principles of a home electrical appliance, to the Internet access portal 3a or 3b of the customer through the communication interface 29 and receives the operating principle selection information from the Internet access portal 3a or 3b of the customer through the communication interface 29. The multimedia document providing module 20b extracts multimedia documents to simulate operating principles provided by the selection information receiving module 20a from the multimedia document database 22 and transmits the multimedia documents to the Internet access portal 3a or 3b.

The shopping information providing method according to an embodiment of the present invention having the above-described structure will now be explained.

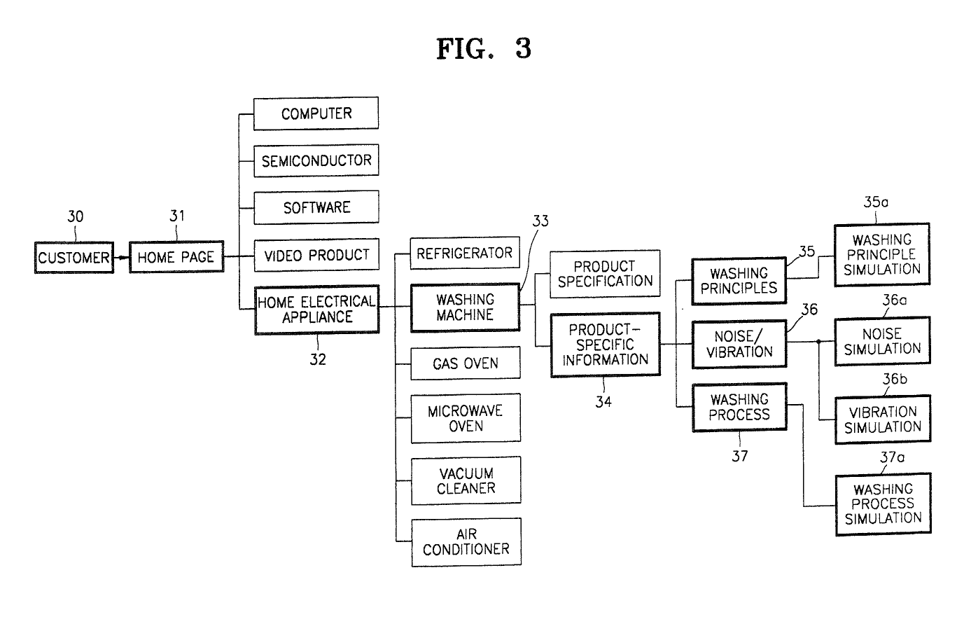

FIG. 3 is a block diagram of the structure of a retrieval path, which is hierarchically expressed, to explain the shopping information providing method using the Internet shopping mall server 1 according to an embodiment of the present invention. For convenience and simplification of explanation, it is assumed that the customer receives shopping information by the retrieval path proceeded along the bold-lined blocks. The customer retrieval path may change in various ways, and shopping information providing method for the other retrieval paths is the same as the following method for a washing machine.

Referring to FIG. 3, in the home page 31 which a customer 30 first accesses, product categories stored in the product database 21 are displayed in a selection menu. The product categories include computers, semiconductors, software, cameras, video products such as televisions, and home electrical appliances, and each product category is formed by an anchor to link to a product item. Here, product categories may be changed in various ways according to classification standards, such as sales strategies, functions of products, prices, etc.

If the customer 30 clicks on home electrical appliances 32, detailed home electrical appliance items including a “refrigerator”, a “washing machine” 33, a “gas oven”, a “microwave oven”, and a “vacuum cleaner” are displayed. Each of these home electrical appliance items is also formed of an anchor to link to a shopping page in which product specification of each model of the home electrical appliance item is displayed.

If the customer 30 clicks on the “washing machine” 33, a shopping page, in which product specifications by model are arranged, is displayed on the Internet access portal 3a or 3b. The product specification includes the external appearance of each model, capacity, size, price, and a brief explanation of the product. The customer 30 can check the product specification and then buy a desired product.

Meanwhile, in the shopping page, product-specific information 34 is arranged as an anchor linking to a product explanation document. If the customer 30 clicks on the product-specific information 34, an operating principle selection page is displayed so that the customer 30 can select the operating principle of the washing machine. More specifically, “washing principles” 35, “noise or vibration” 36, and “washing process” 37 are displayed in the selection menu.

If the customer 30 clicks on the “washing principles” 35, text, graphics, and/or image information to explain the washing principles and an image anchor to simulate the washing principles through moving pictures with or without sound are displayed. If the customer 30 clicks on the image anchor, the washing principles 35a are simulated and displayed with a sound and/or moving pictures linked to the hypermedia structure.

If the customer 30 clicks on the “noise or vibration” 36, text, graphics, and/or image information to explain the noise or vibration and a text anchor or an image anchor to simulate the occurrence and cause of the noise or vibration through moving pictures with or without sound are displayed. If the customer 30 clicks on the text or image anchor, the occurrence and cause of the noise 36a or vibration 36b are simulated with sound and/or moving pictures linked to the hypermedia structure.

It the customer 30 clicks on the “washing process” 37, text, graphics, and/or image information to explain the washing process and an image anchor to simulate the washing process through moving pictures with or without sound are displayed. If the customer 30 clicks on the image anchor, the washing process 37a is simulated with sound and/or moving pictures linked in the hypermedia structure.

Hypermedia pages specifically implemented to simulate the washing principles, the occurrence and cause of noise or vibration, and the washing process will be explained in greater detail later.

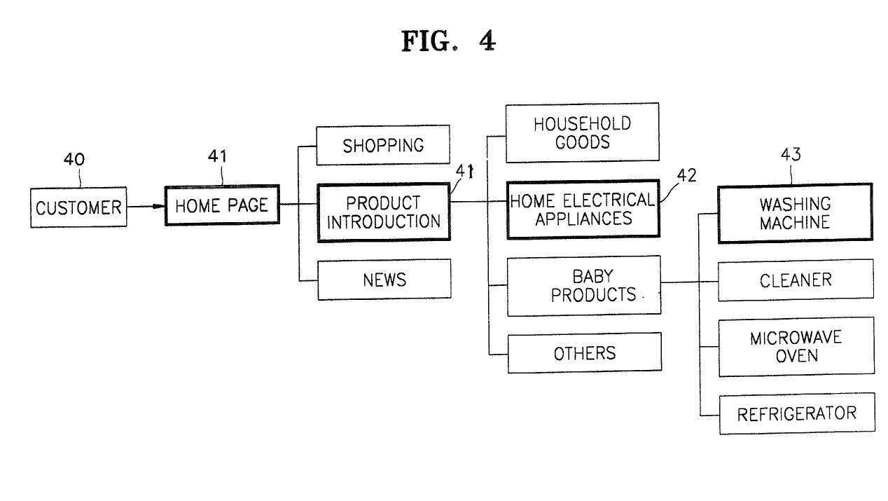

FIG. 4 is a block diagram of the structure of another retrieval path obtained by modifying the retrieval path of FIG. 3. As in FIG. 3, for convenience and simplification of explanation, it is assumed that a customer 40 receives shopping information by the retrieval path proceeded along the bold-lined blocks. Referring to FIG. 4, on a home page 41 which the customer 40 first accesses, “shopping”, “product introduction” 41, and “news” are displayed in a selection menu. If the customer 40 clicks on the “product introduction” 41, “household goods”, “home electrical appliances” 42, “baby products” and other text anchors are displayed in a selection menu.

If the customer 40 clicks on the “home electrical appliances” 42, “washing machine” 43, “vacuum cleaner”, “microwave oven”, and “refrigerator” are displayed in a selection menu. The remaining retrieval path is the same as in FIG. 3.

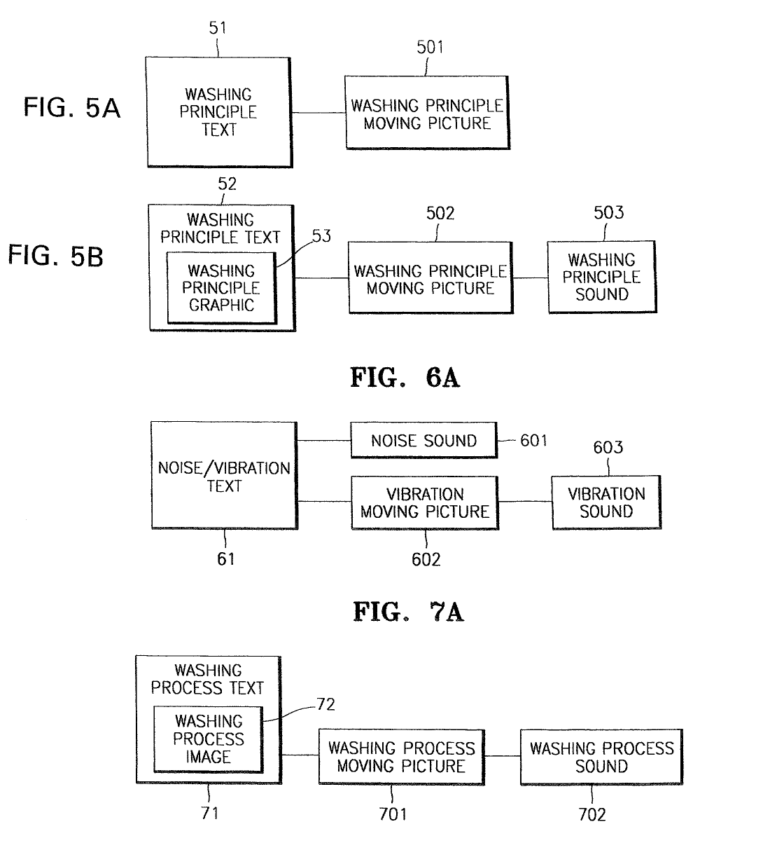

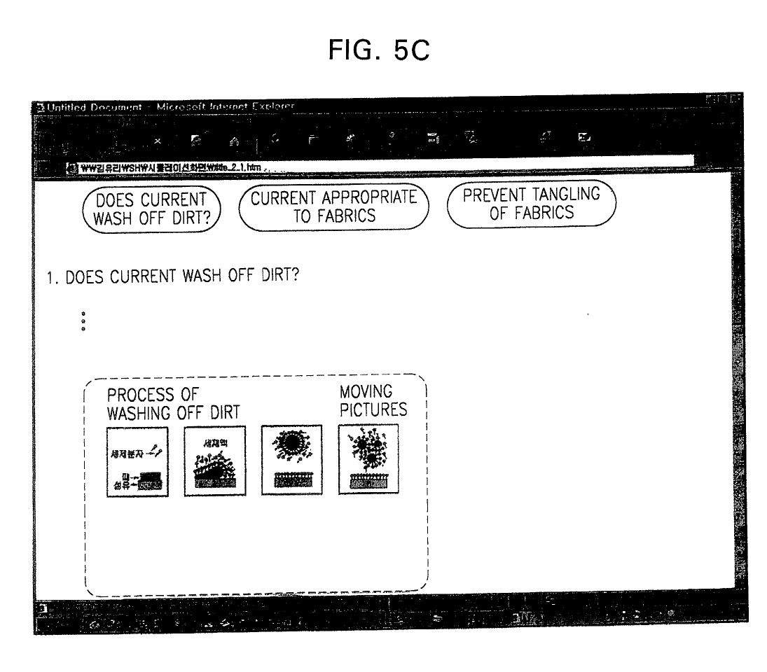

FIGS. 5A and 5B are schematic diagrams of the structure of a hypermedia document to explain washing principles, and FIG. 5C is an example of a web page to implement the structure of FIGS. 5A and 5B. Referring to FIG. 5A, the hypermedia document contains washing principle text 51, in which the washing principles are explained, linked to washing principle moving pictures 501 or FIG. 5B has the hypermedia document in which washing principle text 52 has graphics 53 showing the washing principles is linked to washing principle moving pictures 502 and washing principle sound 503. Referring to FIG. 5C, text and graphics explaining the principle of washing off dirt as a washing principle are displayed, and if the customer wants to watch moving pictures, the process of washing off dirt is simulated using moving pictures and is displayed.

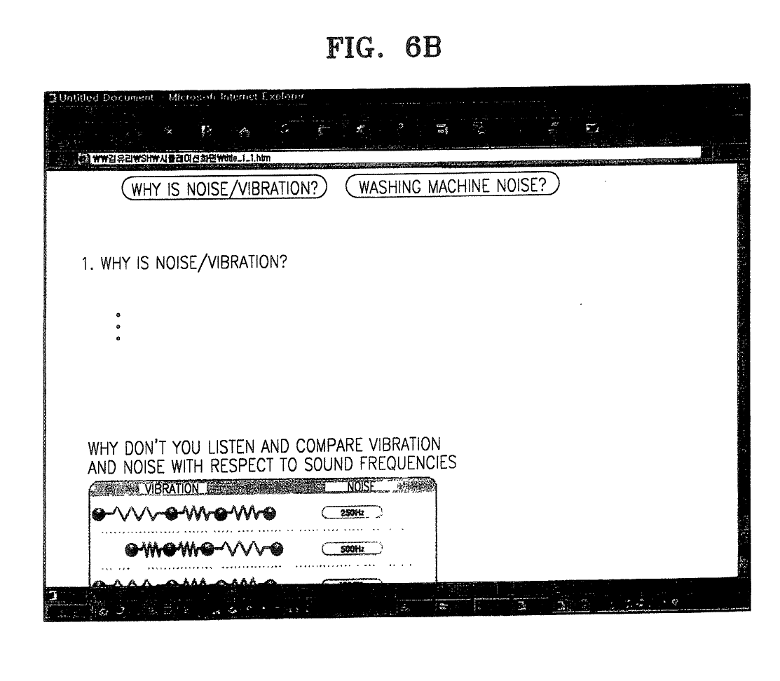

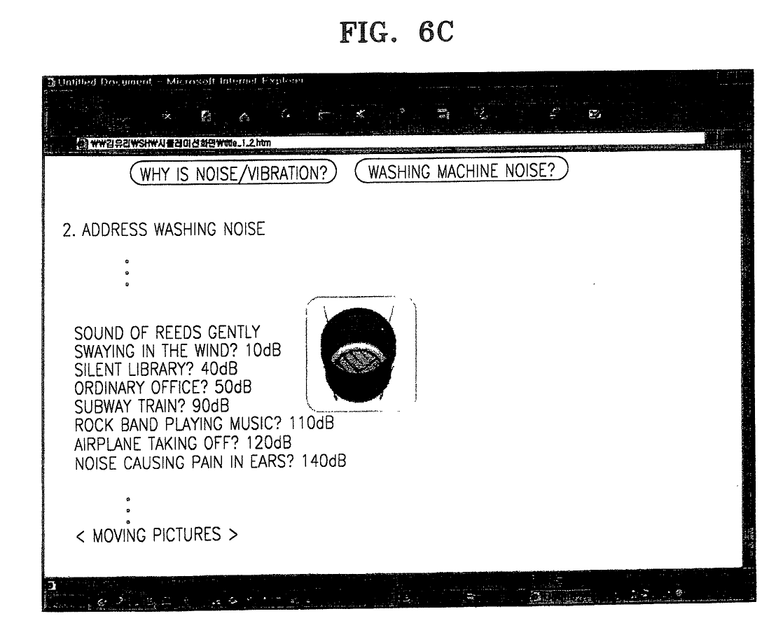

FIG. 6A is a schematic diagram of the structure of a hypermedia document to explain noise or vibration, and FIGS. 6B and 6C are examples of web pages to implement the structure of FIG. 6A. Referring to FIG. 6A, the hypermedia document contains noise or vibration text 61, in which noise or vibration is explained, linked to noise sound 601, vibration moving picture 602, and vibration sound 603. Referring to FIGS. 6B and 6C text to explain the occurrence and cause of noise or vibration and moving pictures showing the vibration principles are displayed, and noise or vibration can be heard or shown.

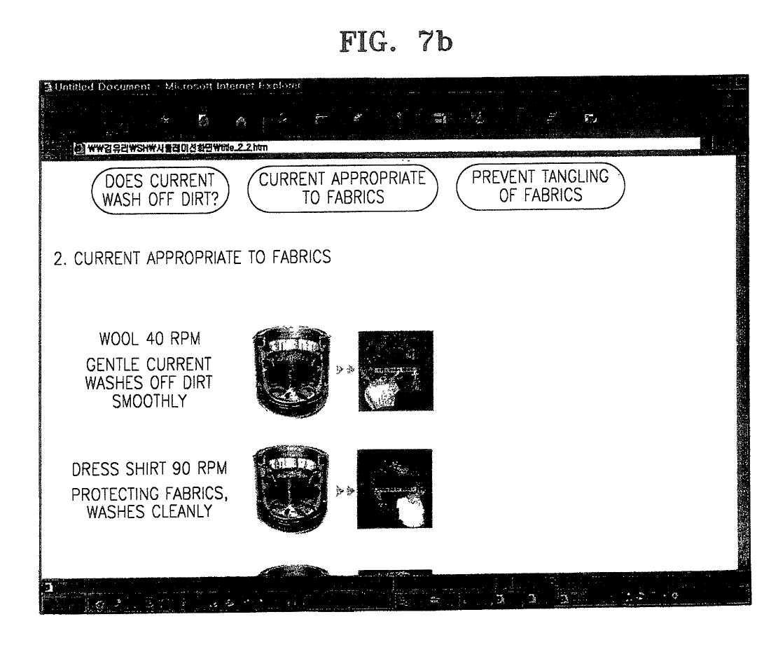

FIG. 7A is a schematic diagram of the structure of a hypermedia document to explain the washing process, and FIG. 7B is an example of a web page to implement the structure of FIG. 7A. Referring to FIG. 7A, the hypermedia document contains washing process text 71, in which is a washing machine image 72 explains the washing process, linked to washing process moving pictures 701 and washing process sound 702. Referring to FIG. 7B, text and a brief description on the rotations of a motor, which corresponds to the strength of the water current and the material of the items being washed, are written. The washing process according to the strength of the water current can be shown or shown and heard.

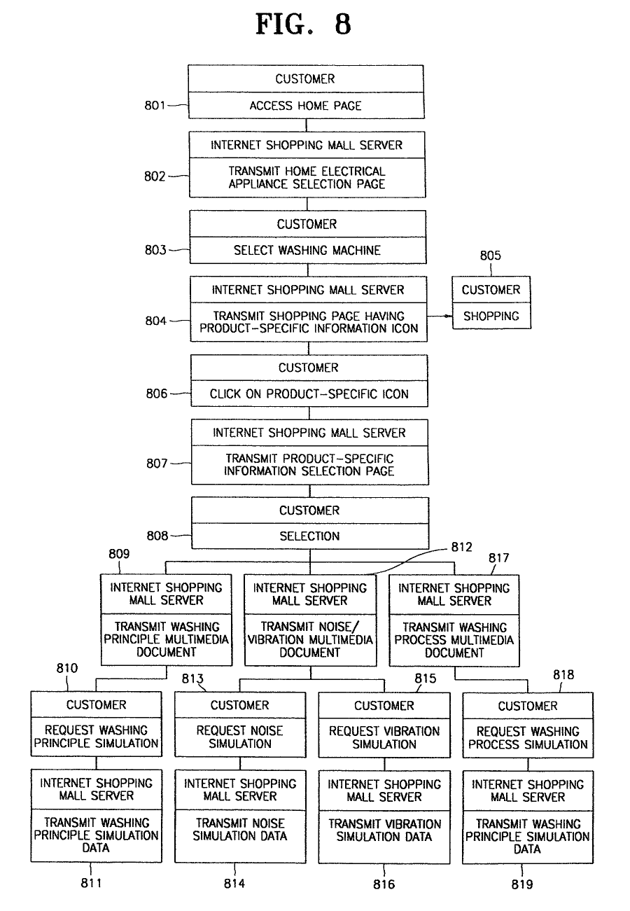

FIG. 8 is a flowchart to explain the shopping information providing method according to an embodiment of the present invention. Here, the shopping information providing method is with reference to the retrieval path shown in FIG. 3. The customer accesses the home page of the Internet shopping mall server 1 through the Internet 5 using Internet access portal 3a or 3b in operation 801. The Internet shopping mall server 1 transmits a home electrical appliance selection page, in which a selection menu to select a home electrical appliance is displayed, to the Internet access portal 3a or 3b in operation 802. If the customer selects a washing machine in operation 803, the Internet shopping mall server 1 transmits a shopping page, in which product specifications are arranged by model, to the Internet access portal 3a or 3b in operation 804. The customer can buy products through the shopping page in operation 805. That is, the customer can look at each model through the shopping page and buy a desired washing machine.

If the customer clicks on an icon for product-specific information in operation 806, the Internet shopping mall server 1 transmits a product-specific information selection page, in which a washing principle icon, a noise or vibration icon, and a washing process icon are arranged to select washing principles, noise or vibration, and washing process, respectively, to the customer's Internet access portal 3a or 3b in operation 807.

If the customer clicks on the washing principle icon in operation 808, the Internet shopping mall server 1 transmits the multimedia documents explained in FIGS. 5A through 5C to the Internet access portal 3a or 3b in operation 809. If the customer clicks on the anchor of FIG. 5C in operation 810, the Internet shopping mall server 1 transmits moving pictures as simulation data to simulate the process of washing off dirt, shown in FIG. 5C, to the customer's Internet access portal 3a or 3b in operation 811.

If the customer clicks on the noise or vibration icon in operation 808, the Internet shopping mall server 1 transmits the multimedia documents explained in FIGS. 6A and 6B to the Internet access portal 3a or 3b in step 812. If the customer clicks on an anchor to hear the noise shown in FIG. 6B in operation 813, the Internet shopping mall server 1 transmits the noise sound as simulation data to the customer's Internet access portal 3a or 3b in operation 814. If the customer clicks on an anchor to hear the vibration shown in FIG. 6B in operation 815, the Internet shopping mall server 1 transmits the vibration sound 603 shown in FIG. 6A to the customer's Internet access portal 3a or 3b in operation 816.

If the customer clicks on the washing process icon in operation 808, the Internet shopping mall server 1 transmits the multimedia documents explained in FIGS. 7A and 7B to the Internet access portal 3a or 3b in operation 817. If the customer clicks on an anchor prepared to watch or hear the washing process shown in FIG. 7B in operation 818, the Internet shopping mall server 1 transmits washing process moving pictures 701 and washing process sound 702 as simulation data to the customer's Internet access portal 3a or 3b in operation 819.

In the embodiments described above, the home electrical appliances, which represent the products, and the multimedia documents prepared for the washing principles, noise or vibration, and washing process, which represent the operating principles of a washing machine, are explained. However, multimedia documents similar to the embodiments described above can be prepared and provided for other home electrical appliances. Particularly, since personal computers are widely used at home, multimedia documents on the usage of personal computers can be provided.

Though hypermedia documents are explained as multimedia documents in the embodiments described above, multimedia documents having other structures written with various multimedia document authoring tools may also be used as to create multimedia documents including animated GIFs, DHTML, Active X control, Javascript, Java Applets, Quicktime, MPEG, and Shockwave.

As described above, according to the present invention, there are provided an Internet shopping mall server which provides multimedia documents to describe operating principles for a product as shopping information to customers and a shopping information providing method thereof. Accordingly, customers, whether home customers or industrial customers, can easily understand the operating principles of a product. Specifically, when the operating principles of home electrical appliances are provided in multimedia documents, the customers of the products can easily understand the operating principles. Therefore, the Internet shopping mall operator can enhance customer loyalty to the Internet shopping mall and improve the goodwill of the Internet shopping mall. Also, customers can receive operating principles, usage operation, and scientific knowledge of products through the Internet shopping mall. In addition, since the customers can more proficiently operate the products, the occurrences of accidents caused by the products can be reduced.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A shopping information providing method of an Internet shopping mall server, the shopping information providing method comprising:
receiving a request for a product explanation on a predetermined product from a customer;
transmitting an operating principle selection page used to select one of the operating principles of the predetermined product to an Internet access portal of the customer;
receiving selection information on a selected one of the operating principles selected by the customer from the Internet access portal; and
transmitting a multimedia document to simulate the selected operating principle to the Internet access portal.

2. The method of claim 1, wherein the predetermined product comprises a home electrical appliance.

3. The method of claim 2, wherein the home electrical appliance is any one of a washing machine, a vacuum cleaner, a microwave oven, a gas oven, and an air conditioner.

4. The method of claim 1, wherein the predetermined product comprises a washing machine, and the multimedia document comprises a hypermedia document to link to a sound to simulate a noise or a vibration of the washing machine.

5. The method of claim 1, wherein the predetermined product comprises a washing machine, and the multimedia document comprises a hypermedia document to link to a sound and moving pictures to simulate a noise or a vibration of the washing machine.

6. The method of claim 1, wherein the predetermined product comprises a washing machine, and the multimedia document comprises a hypermedia document to link to moving pictures to show a principle of washing off dirt.

7. The method of claim 1, wherein the predetermined product comprises a washing machine, and the multimedia document comprises a hypermedia document to link to a sound and moving pictures to simulate the washing process according to a strength of a water current in the washing machine.

8. The method of claim 7, wherein the multimedia document comprises a hypermedia document to link to the sound and the moving pictures to display appropriate rotations of a motor depending on a material of clothing items and to simulate a washing process according to the water current caused by the motor rotations.

9. An Internet shopping mall server, comprising:
a product database to store information on products;
a communication interface to communicate data through an Internet;
a selection information receiving module
to receive a request for a product explanation on a predetermined product from an Internet access portal of a customer,
to transmit an operating principle selection page to select any one of the operating principles of the predetermined product to the Internet access portal through said communication interface, and
to receive operating principle selection information from the Internet access portal through said communication interface; and
a multimedia document providing module
to extract a multimedia document to simulate the one of the operating principles according to the operating principle selection information from said multimedia document database, and
to transmit the multimedia document to the Internet access portal.

10. The server of claim 9, wherein the predetermined product comprises a home electrical appliance.

11. The server of claim 10, wherein the home electrical appliance is any one of a washing machine, a vacuum cleaner, a microwave oven, a gas oven, and an air conditioner.

12. The server of claim 10, wherein the multimedia document comprises a hypermedia document to link to a sound to simulate a noise or a vibration of a washing machine.

13. The server of claim 10, wherein the multimedia document comprises a hypermedia document to link to a sound and moving pictures to simulate a noise or a vibration of a washing machine.

14. The server of claim 10, wherein the multimedia document comprises a hypermedia document to link to moving pictures to show a principle of washing off dirt.

15. The server of claim 10, wherein the multimedia document comprises a hypermedia document to link to a sound and moving pictures to simulate a washing process according to a strength of a water current in a washing machine.

16. The server of claim 15, wherein the hypermedia document links to the sound and the moving pictures to display appropriate rotations of a motor depending on a material of clothing items, and to simulate simulating the washing process according to the water current caused by the motor rotations.

17. A method of providing product information using a server, the method comprising:
receiving a request for product information on a predetermined product from an Internet access portal;
providing an operating principle selection page based on said receiving the request for product information to the Internet access portal, the operating principle selection page comprising a reference to an operating principle of the predetermined product;
receiving selection information to select the operating principle from the Internet access portal; and
providing a multimedia document to demonstrate the selected operating principle to the Internet access portal.

18. The method of claim 17, further comprising providing a catalog comprising a catalog reference to the product information, and wherein said receiving the request for the product information further comprises receiving the request for the product information based upon the catalog reference to the product information.

19. The method of claim 18, further comprising providing a product type information comprising a product type reference to the product information, the product type information being referenced by the catalog reference, wherein said receiving the request for the product information further comprises receiving the request for the product information based upon the product type reference and the catalog reference.

20. The method of claim 17, wherein the multimedia document comprises audio data related to the selected operating principle.

21. The method of claim 17, wherein the multimedia document comprises video data related to the selected operating principle.

22. The method of claim 21, wherein the multimedia document further comprises audio data related to the selected operating principle.

23. The method of claim 17, further comprising
retrieving the product information from a product information database based upon said receiving the request for the product information; and
retrieving the multimedia document from a multimedia document database based upon said receiving the selection information.

24. A computer readable medium encoded with processing instructions for implementing a method of providing product information performed by a computer, the method comprising:
receiving a request for product information on a predetermined product;
providing an operating principle selection page based on said receiving the request for product information, the operating principle selection page comprising a reference to an operating principle of the predetermined product;
receiving selection information to select the operating principle; and
providing a multimedia document to demonstrate the selected operating principle.

25. The computer readable medium of claim 24, wherein the method further comprises providing a catalog comprising a catalog reference to the product information, and wherein said receiving the request for the product information further comprises receiving the request for the product information based upon the catalog reference to the product information.

26. The computer readable medium of claim 25, wherein the method further comprises providing a product type information comprising a product type reference to the product information, the product type information being referenced by the catalog reference, wherein said receiving the request for the product information further comprises receiving the request for the product information based upon the product type reference and the catalog reference.

27. The computer readable medium of claim 24, wherein the multimedia document comprises audio data related to the selected operating principle.

28. The computer readable medium of claim 24, wherein the multimedia document comprises video data related to the selected operating principle.

29. The computer readable medium of claim 29, wherein the multimedia document further comprises audio data related to the selected operating principle.

30. The computer readable medium of claim 29, wherein the multimedia document further comprises audio data related to the selected operating principle.

31. The computer readable medium of claim 29, wherein the method further comprises
retrieving the product information from a product information database based upon said receiving the request for the product information; and
retrieving the multimedia document from a multimedia document database based upon said receiving the selection information.
